(19) United States
(12) Patent Application Publication
(10) Pub. No.: US 2006/0072872 A1
(43) Pub. Date: Apr. 6, 2006

(54) Switches for changing optical path and selecting wavelength

(75) Inventor: Nobuaki Mitamura, Yokohama (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/042,143

(22) Filed: Jan. 26, 2005

(30) Foreign Application Priority Data
Oct. 5, 2004 (JP) 2004-292171

(51) Int. Cl. G02B 6/26

(52) U.S. Cl. 385/18; 385/24

(57) ABSTRACT

In a wavelength selecting optical switch, a shutter is situated near an incident position, which is a position at which the light falls onto the mirrors, and has a plurality of blocking members that prevent or allow light to be incident onto respective mirrors. Moreover, a control unit controls a blocking member corresponding to a mirror of which an angle is to be changed so that the blocking member prevents the light to be incident onto the corresponding mirror.

### CROSS-REFERENCE TO RELATED APPLICATIONS

This application is based upon and claims the benefit of priority from the prior Japanese Patent Application No. 2004-292171, filed on Oct. 5, 2004, the entire contents of which are incorporated herein by reference.

### BACKGROUND OF THE INVENTION

1) Field of the Invention

The present invention relates to an optical path changing-over switch that switches an optical path in a large scale optical network to which a plurality of WDM networks are connected, and to a wavelength selecting optical switch that branches arbitrary wavelength signal light for each wavelength.

2) Description of the Related Art

Owing to recent robust prevalence of high-speed access networks that use a bandwidth of about 100 megabit/second, broadband Internet services are more commonly shared. Fiber to The Home (FTTH) and Asymmetric Digital Subscriber Line (ADSL) are the examples of such networks. To respond to the increased demand for these communication services, ultra-large capacity optical communication systems that use a wavelength multiplexing technique have become common in backbone network (core network). It is expected that the optical fiber networks will be laid all over in the near future.

If the optical fiber networks are laid all over and they are connected with each other, a function of “intersection” that controls the traffic will be inevitable. An optical switch is used to switch an inputted optical signal to an intended output end.

Since the optical switch processes an optical signal as it is, there is no need to provide a photo diode (PD) or the like for converting the optical signal to an electric signal. Additional advantage is that switching can be executed regardless of rate and format of the data transmission. Since the optical switches are better, they are replacing the electric switches in networks.

Furthermore, optical networks are also applied to metro (metropolitan area) network and FTTH. Also it is a trend to use an optical network for connecting a server machine and a router in a data center. To organically connect these optical networks at many points, a switching function becomes inevitable. An optical switch operates in any of the following three manners depending on the application known in the art:

(1) Switching a connection end of the optical fiber;

(2) withdrawing or inserting an optical signal of specific wavelength; and

(3) switching an optical signal of specific wavelength to a specific path.

In addition, the electric switching ability at connections between the metro network and the core network is still limited. In addition, these connections are susceptible to be band bottlenecks. For addressing these problems, in recent years, it seems effective to construct a new photonic network architecture that directly connects an access network and a core network in an optical area without intervened by an electric switch, by providing a new optical switching node in a metro area which is a band bottleneck.

One function of the optical switching emphasized in these days is to conduct switching while selecting a specific wavelength from one fiber. Such function is realized by a so-called wavelength selecting optical switch.

As concrete applications of the wavelength selecting optical switch include, for example, a wavelength selecting optical router that controls and routes individual wavelength signals from an inputting fiber to an output fiber, a wavelength selecting optical node bypass that bypasses a specific wavelength from one fiber to an alternative fiber, and a wavelength selecting insertion/branching apparatus (OADM: Optical Add/Drop Multiplexer) that controls insertion/withdrawing of a specific wavelength from one fiber.

A variety of constitutions have been proposed for such a wavelength selecting optical switch. FIG. 15 is a view of a constitution of a conventional wavelength selecting optical switch. This wavelength selecting optical switch includes an input optical port 1, a diffraction grating 2, a lens 3, a mirror array 4, and a plurality of output optical ports 5 including ports #1 to #5. A plurality of parallel signal beams (light beams) having different wavelengths outputted from the input optical port 1 are first separated into different angular directions by means of the diffraction grating 2. These light beams are then focused on different positions by the lens 3, and guided to the intended output beam ports 5 after reflected at intended angles by the mirror array 4 made up of M angular-variable micro mirrors located at focusing positions. Conventional wavelength selecting optical switches are disclosed in, for example, U.S. Pat. No. 6,549,699 and Japanese Patent Application Laid-Open Publication No. 2003-515187.

Japanese Patent Application Laid-Open Publication No. 2002-262318 discloses a measure to this problem. Specifically, this publication teaches to control a movable mirror so that an optical signal deflected by the movable mirror during a path switching period will not be outputted to any output port other than the intended output port which is to be set as a new path.

However, the problem of crosstalk is inevitable in an optical switch using a Micro Electro Mechanical Systems (MEMS) mirror. For example, in the wavelength selecting optical switch shown in FIG. 15, if a signal beam of a specific wavelength is to be switched from a port #1 to a port #5, the MEMS mirror is angularly moved so that the light beam of the specific wavelength moves in a straight line from the port #1 to the port #5. If the light beam is moved in a straight line, the switching can be performed in the shortest time; however, during the movement, the light beam enters ports #2 to #4 and causes a crosstalk (hereinafter, “dynamic crosstalk”).

The crosstalk problem is not peculiar to the wavelength selecting optical switch, but can occur in any optical switch that spatially changes an advancing direction of a light beam.

In the case of an optical switch using an MEMS mirror, such a crosstalk problem is often pointed out. Crosstalk is a phenomenon that when a micro mirror is moved to switch the output port end, an optical signal leaks into other ports. The larger the number of the input/output ports the more significant the problem becomes, and this may potentially introduce restrictions on miniaturization of mirrors and reduction of their pitch.

Japanese Patent Application Laid-Open Publication No. 2003-515187 discloses a technique to solve the problem of occurrence of the dynamic crosstalk. Specifically, this publication teaches to control a movable mirror so that an optical signal deflected by the movable mirror is not outputted to any other output ports than an output port for which a new path setting is to be made during path switching period. However, in this technology, a biaxially-driven movable mirror becomes necessary. This leads the problems of complicated control and prolonged switching time.

Japanese Patent Application Laid-Open Publication No. 2002-262318 discloses a method of adding a blocking device that blocks an optical signal in a previous stage of an input port during path switching period. However, this method cannot be adopted in a wavelength selecting optical switch because if the light is blocked in previous stage of an input port, all the signal lights are blocked.

Furthermore, in the optical switching node, light routes on the network often change dynamically due to switching operation, and a loss changes depending on the length of optical fiber of a particular route and the number of inserted optical components. Accordingly, also the signal intensity level often changes. Therefore, the wavelength selecting optical switch is requested to have a variable attenuation ability to adjust the intensity level of wavelength signal light, as well as an ability to switch the optical path.

### SUMMARY OF THE INVENTION

It is an object of the present invention to solve at least the problems in the conventional technology.

An optical path changing-over switch according to an aspect of the present invention is a switch in which wavelengths entering a plurality of mirrors are different from each other, and light is emitted while switching optical paths of light into selected directions for each wavelength by changing angles of the mirrors. The optical path changing-over switch includes a shutter situated near an incident position that is a position at which the light falls onto the mirrors and has a plurality of blocking members that prevent or allow light to be incident onto respective mirrors; and a control unit that controls a blocking member corresponding to a mirror of which an angle is to be changed so that the blocking member prevents the light to be incident onto the corresponding mirror.

A wavelength selecting optical switch according to another aspect of the present invention includes a wavelength dispersing element that separates an incident light into a plurality of light beams based on wavelengths that travel at different angles and emits the light beams; a lens that focuses each of the light beams at a different position; a mirror array including a plurality of rotatable mirrors, each mirror being located at a position corresponding to the position where the lens focuses the light beams, the mirror array reflecting the light beams toward the wavelength dispersing element via the lens, directions of the light beams reflected by the mirrors is in accordance with angles of the mirrors; a plurality of output ports provided at positions where the light beams returned depending on the mirror angles of the mirror array by the wavelength dispersing element are condensed; and a shutter having a blocking unit that blocks the light beams, wherein the shutter is disposed in an optical path of a corresponding light beam from the wavelength dispersing element for each mirror. When angles of the mirrors are changed, a light beam is blocked by a corresponding blocking unit.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a perspective of a wavelength selecting optical switch according to a first embodiment of the present invention;

FIG. 2A is a front view of a mirror array shown in FIG. 1;

FIG. 2B is an operation view of the mirror array shown in FIG. 1;

FIG. 3 is a front view of a shutter array shown in FIG. 1;

FIG. 4 is an enlarged perspective of the mirror array and the shutter array shown in FIG. 1;

FIG. 5 is a top view of a traveling path of light;

FIG. 6 is a flowchart of an optical path switching operation according to the present invention;

FIG. 7A is a front view of an arrangement according to a second embodiment of the present invention;

FIG. 7B is a side view of the arrangement shown in FIG. 7A;

FIG. 8 is front view of a modification of the arrangement shown in FIG. 7A;

FIG. 9 is schematic an optical shutter according to a third embodiment of the present invention;

FIG. 10 is a schematic of a polarization rotary element shown in FIG. 9;

FIG. 11 is schematic of a modification of the optical shutter shown in FIG. 9;

FIG. 12 is a top view of a wavelength selecting optical switch that makes incident light independent of the light polarization;

FIG. 13 is a graph of a relationship between polarization rotation angle and transmission loss in a fourth embodiment of the present invention;

FIG. 14 is a graph explaining a wavelength-variable filter of a fifth embodiment of the present invention; and

FIG. 15 is a conventional wavelength selecting optical switch.

### DETAILED DESCRIPTION

Exemplary embodiments of the present invention are explained below with reference to accompanying drawings.

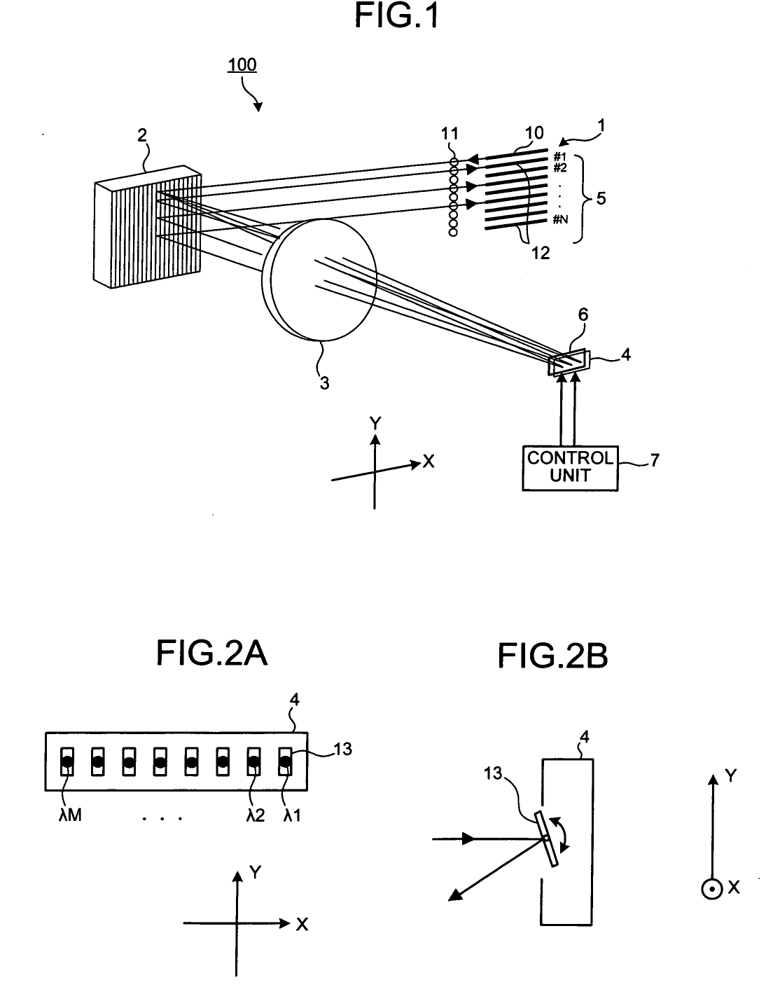

FIG. 1 is a wavelength selecting optical switch 500 according to a first embodiment of the present invention. The wavelength selecting optical switch includes one input optical port 1, a diffraction grating 2, a lens 3, a mirror array 4, and N (ports #1, #2, . . . #N) output optical ports 5. The wavelength selecting optical switch 100 further includes a shutter array 6 and a control unit 7. The diffraction grating 2 and the mirror array 4 are located generally at a focal length of the lens 3.

The input optical port 1 consists of an input optical fiber 10 and a collimate lens 11. The input optical fiber 10 is a transmission path made of glass, through which an optical signal passes.

The diffraction grating 2 is a wavelength dispersing element that separates incident light in which wavelengths are multiplexed, into different angles based on the wavelength. The light entered the diffraction grating 2 is emitted as light beams having different wavelengths depending on the angle due to a diffraction phenomenon. The diffraction grating 2 depicted in FIG. 1 is a reflective diffraction grating. Diffraction gratings are generally classified into reflective diffraction gratings and transmissive diffraction gratings. Examples of the reflective diffraction gratings include a reflective amplitude grating, a reflective phase grating, and a reflective breathed grating. Examples of the transmissive diffraction gratings include a transmissive amplitude grating and a transmissive phase grating.

The reflective amplitude grating is produced by forming a certain pattern of thin reflective metal film at even pitch intervals on a non-light-reflective substrate. The reflective phase grating is produced by forming a reflective metal sheet on a substrate having a certain pattern of grooves at even pitch intervals. When a transmissive diffraction grating is used as the diffraction grating 2, the input optical port 1, the diffraction grating 2, the lens 3 and the mirror array 4 are disposed on the incident side with respect to the mirror array 4, and also on the light emission side with respect to the mirror array 4, the set of the diffraction grating 2, the lens 3 and the output optical ports 5 constituted in the same manner is disposed.

The mirror array 4 is disposed at a focal point of light beam by the lens 3. The mirror array 4 consists of a plurality (the same number as that of wavelengths) of angle-variable micro mirrors 13. Each micro mirror 13 returns an inputted light beam to the diffraction grating 2 via the lens 3. The direction of returned light beam depends on the angle of the micro mirror 13. In front of a light incident position of the mirror array 4, a shutter array 6 serving as a blocking unit is provided. The shutter array 6 consists of a plurality of micro shutters 14 each corresponding to each micro mirror 13. Each micro shutter 14 is located in an optical path of a corresponding light beam from the diffraction grating 2, for each micro mirror 13. The micro shutter 14 serves as a blocking member for blocking a light beam from entering the corresponding micro mirror 13. When changing an angle of one micro mirror 13, a light beam is blocked by corresponding one micro shutter 14. Details of these micro mirrors 13 and the micro shutters 14 will be described later.

The output optical ports 5 include N sets of a collimate lens 11 and an output optical fiber 12. The output optical fiber 12 is an optical fiber similar to the input optical fiber 10. A light beam is returned according to a mirror angle of each micro mirror 13 of the mirror array 4. The output ports 5 are each provided at a position where this light beam focuses.

The control unit 7 connects with the mirror array 4 and controls each of the M micro mirrors 13. The mirror array 4 causes incident light to be emitted in an intended direction by changing an angle of the micro mirror 13 using electromagnetic force or electrostatic force. The control unit 7 connects with the shutter array 6, and controls opening/closing of each of the M micro shutters 14. The shutter array 6 also controls opening/closing of the micro shutters 14 using, for example, electromagnetic force or electrostatic force. Incident light to the micro mirror 13 of the micro array 4 can be blocked by moving the micro shutter 14 of the shutter array 6. Not limited to this, such a constitution that light passage is optically blocked can be employed in place of the constitution in which the micro shutter 14 is mechanically moved (details will be described later).

Next, using FIG. 1, a wavelength selecting operation of the wavelength selecting optical switch will be explained. The light including M different wavelengths having subjected to wavelength multiplexing is emitted from an emission end of the input light fiber 10. The emitted light is changed into parallel light beams (collimate beams) by the collimate lens 11 and introduced to the diffraction grating 2.

The diffraction grating 2 separates the light in the form of a single parallel beam including M wavelengths into different angular directions (laterally in FIG. 1) based on the wavelength to branch it into a plurality of parallel beams whose advance directions (angles) are different from each other. As can be seen in the top view of the wavelength selecting optical switch 100 of FIG. 1, the diffraction grating 2 make the light beams of respective wavelengths emit while being shifted from each other in a lateral direction (X direction in the drawing).

The lens 3 condenses the M light beams having different wavelengths traveling different advance directions (angles) at different positions. The diffraction grating 2 is located at an approximately focal length of the lens 3. The lens 3 condenses the M light beams having different wavelengths separated by the diffraction grating 2 at the respective focal positions while shifting them in parallel. The M light beams having different wavelengths are condensed side by side at almost uniform intervals along the X direction in FIG. 1, in the case of an even frequency interval as is generally used in WDM networks. It is to be noted that, strictly, intervals between wavelengths are not constant even when frequency interval is constant, and the angular interval is not uniform according to the principle of the diffraction grating 2, so that intervals of condensing positions are slightly shifted from with each other.

FIG. 2A is a front view of the mirror array 4 and FIG. 2B is an operation view of the mirror array 4. The mirror array 4 includes the M angle-variable micro mirrors 13 disposed at focal positions of the M light beams having different wavelengths (λ1 to λM) condensed by the mirror 3. As shown in FIG. 2B, each of the M micro mirrors 13 can be angularly moved in the vertical direction (Y direction). Therefore, the M light beams having different wavelengths entered the micro mirrors 13 are emitted after reflected at different angles, and returned to the diffraction grating 2 through the lens 3. Light beams enter (and leave) the mirror 13 at right angles when viewed from the top face (plane perpendicular to the Y direction) of FIG. 1.

The control unit 7 controls the M micro mirrors 13 provided in the mirror array 4 so that each of the light beams having different wavelengths is angularly changed at uniform angular intervals in N levels. The number N corresponds the number of the output optical ports 5. The mirror array 4 can be implemented by, for example, movable mirrors based on electrostatic attraction, and in this case, the micro mirrors 13 can be switched in predetermined angle levels by applying a predetermined power on each of the micro mirrors 13.

In this manner, a light beam reflected at each micro mirror 13 provided for each of the M wavelengths enters the lens 3 and the diffraction grating 2 at a vertical level which is different from that of the remainder of the M wavelengths. The light beam reflected by the micro mirror 13 again enters the lens 3 where it is shaped to a parallel beam, and then enters the diffraction grating 2. Since the mirror array 4 is located at an approximately focal length of the lens 3, the light beams reflected at the angles of the micro mirrors 13 will be parallel with each other along the vertical direction (Y direction). The number of light beams reflected by the micro mirrors 13 reaches up to N. Since angles of the micro mirrors 13 are changed evenly and stepwise in N levels, also the vertical (Y-directional) intervals of light are uniform.

A plurality of (up to N) light beams which are equally spaced in the vertical direction (Y direction) again enter the diffraction grating 2. The light beams returning to the diffraction grating 2 have the same angles as the angles (X direction) of light beams diffracted by the diffraction grating 2. Accordingly, the diffraction grating 2 diffract the light to the output optical ports 5 located in the same direction (angle) as the direction (angle) of the light entered from the input optical port 1. The up to N light beams returning to the diffraction grating 2 enter the diffraction grating 2 while keeping the uniform intervals in the vertical direction (Y direction).

The (up to N) light beams evenly spaced in the vertical direction (Y direction) enter the N output optical ports 5 disposed at the same intervals as the interval of the light beams. The N light beams are optically coupled to the N output light fibers 12 by the collimate lens 11 constituting the output optical ports 5. As a result, the angles of the M micro mirrors 13 provided in the mirror array 4 are changed in N levels, and light beam of intended wavelengths (λ1 to λM) can be outputted through the intended output optical ports 5 (output optical fibers 12).

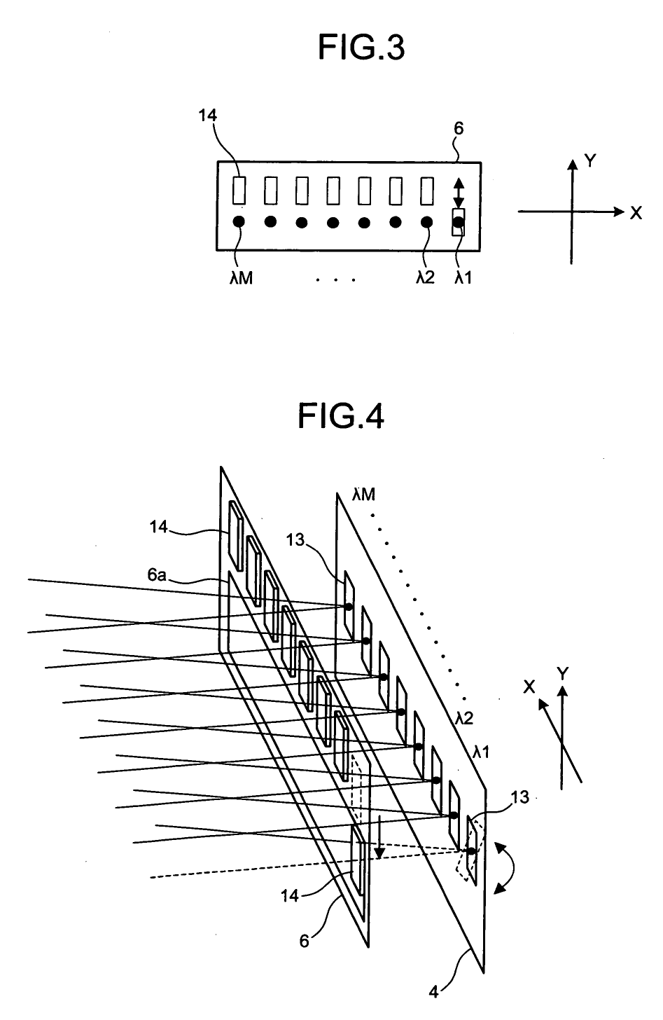

FIG. 3 is a front view of the shutter array 6. The shutter array 6 can block exclusively signal light of a specific wavelength as necessary. In the wavelength selecting optical switch 100, the position where the light beams of different wavelengths are spatially separated at largest intervals is their focal positions near the M micro mirrors 13. Directly before the micro mirrors 13, the shutter array 6 consisting of M micro shutters 14 is disposed.

As describe above, by controlling angles of the micro mirrors 13, it is possible to emit the light beams while switching the optical path of light beams of intended wavelengths, so that wavelength selecting optical switching function is obtained. During this switching of optical path, a dynamic crosstalk occurs. Since a dynamic crosstalk is caused by the light beam corresponding to the micro mirror 13 which is being subjected to angular change, micro mirrors not moving will not cause a crosstalk.

In other words, in changing an angle of one micro mirror 13, one micro shutter 14 disposed directly before the micro mirror 13 is close to block the optical path. The micro shutters 14 disposed directly before the micro mirrors 13 whose angle is not changed, are kept open because they need not block the optical paths. As a result, it is possible to block the light to the minimum necessary. As to the light beam of a wavelength for which optical path is to be changed, entry of an optical signal is blocked during the period when the micro mirror 13 moves, whereby occurrence of a crosstalk is prevented. On the other hand, as to a light beam of a wavelength for which optical path is not to be changed, the light beam is not blocked so that communication via optical signals can be continued.

The micro shutters 14 used in the shutter array 6 can be implemented by, for example, a movable shutter using an electrostatic attraction-based movable element (MEMS shutter). The micro shutter 14 generates an electrostatic attraction in response to application of an electric power, and moves horizontally (in the direction of arrow in the drawing). Such an electrostatic attraction-based MEMES shutter can be readily produced using a fine processing technique for semiconductor.

FIG. 4 is an enlarged perspective view of the mirror array 4 and the shutter array 6. The light beams of different wavelengths, which are aligned in the lateral direction (Y direction), enter the mirror array 4 through an opening 6a of the shutter array 6.

The shutter array 6 includes a plurality of micro shutters 14 aligned in the lateral direction. The micro shutters 14 are positioned at corresponding positions of the micro mirrors 13 of the mirror array 4. The number of the micro mirrors 13 is equal to that of the micro shutters 14, and coincides with the number M of wavelengths to be entered (λ1 to λM).

Each of the M micro shutters 14 is movable (rotatable) independently in the vertical direction. In the example of FIG. 4, the micro shutter 14 is open when the micro shutter 14 is positioned above the opening 6a. When the micro shutter 14 is open, the light beam having a wavelength corresponding to the open micro shutter 14 passes through the opening 6a and enters the micro mirror 13 of the mirror array 4. The light beam entered the micro mirror 13 is reflected by the micro mirror 13, and is returned while passing below the micro shutter 14 (opening 6a) again.

On the other hand, when the micro shutter 14 is closed, the light beam having a wavelength corresponding to the closed micro shutters 14 is blocked and prevented from entering the micro mirror 13. In the above description, the opening 6a is provided in the shutter array 6, however, the micro shutter 14 may move to the position corresponding to the opening 6a rather than providing the opening 6a in the shutter array 6.

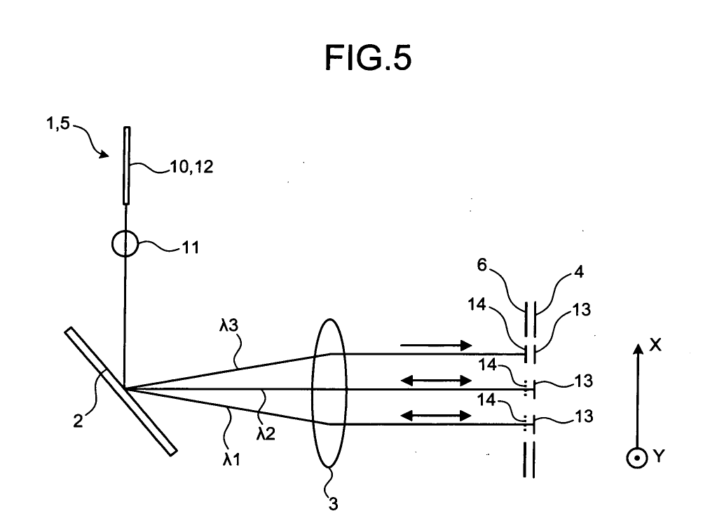

FIG. 5 is a schematic for explaining how the light travels in FIG. 1. This corresponds to the constitution of FIG. 1 viewed from above. For convenience of illustration it is assumed here that the number of wavelengths is 3 (λ1 to λ3). The light falls on the diffraction grating 2 where it is separated into light beams of respective wavelengths. These light beams of respective wavelengths then enter the lens 3 where they are made parallel. These parallel light beams are reflected into the same direction by the micro mirrors 13.

As shown with the dotted line in FIG. 5, the light beams having wavelengths λ1, λ2 corresponding to the open micro shutters 14 pass through the shutter array 6, enter the mirror array 4, and again pass through the shutter array 6 after reflected by the micro mirrors 13. On the other hand, as shown by the solid line in FIG. 5, the light beam having a wavelength λ3 corresponding to the closed micro shutter 14 is prevented from entering the mirror array 4 by the micro shutter 14, so that the light beam cannot be reflected by the mirror array 4.

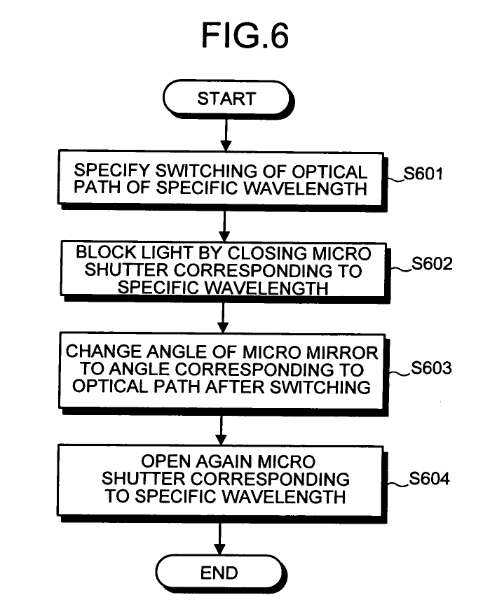

FIG. 6 is a flowchart of an optical path switching operation according to the present invention. An operation that prevents a dynamic crosstalk during optical path switching will be explained using FIG. 6. First, the control unit 7 specifies switching of an optical path of a specific wavelength (step S601). Next, the control unit 7 closes the micro shutter 14 corresponding to this specified wavelength to block the light (step S602).

Then the control unit 7 changes the angle of the micro mirror 13 to the angle that corresponds to the optical path after switching (step S603). As described above, when the micro mirror 13 is implemented by an electrostatic attraction-based movable mirror, it can be changed at any angle by application of a predetermined electric power.

After changing the angle of the micro mirror 13 to a predetermined angle, the control unit 7 opens again the micro shutter 14 corresponding to the specific wavelength which has been closed (step S604). At this time, the micro shutter 14 again allows the light to pass through, resulting that the light beam having the specific wavelength is emitted to the changed-over out optical port 5. Since the light beam of the specific wavelength is blocked with the micro shutter 14 during switching of the optical path, it will not enter any output optical port 5, preventing occurrences of dynamic crosstalk during switching of the optical path.

Now the switching operation of optical path will be explained in detail. Explanation will be given while taking the case in which the light beam having shortest wavelength is switched from the port #1 to the port #5 of the output optical ports 5, as an example. At step S602, light is blocked by closing the micro shutter 14 disposed directly before the micro mirror 13 to which a signal light having the shortest wavelength condenses. As a result, light emission to the port #1 is blocked. Next, at step S603, the angle of the micro mirror 13 is changed to the angle for switching to the port #5. At the subsequent step S604, the closed micro shutter 14 is opened. At this time, since the light beam having the shortest wavelength is allowed to pass through, the light beam having the shortest wavelength is emitted to the port #5 of the output optical ports 5.

In the period during which the angle of the micro mirror 13 is changed (step S602 to step S603), the light beam of the shortest wavelength will not enter any of the output optical ports 5 because it is blocked by the micro shutter 14. Accordingly, it is possible to prevent dynamic crosstalk during switching of the optical path.

As explained above, according to the first embodiment, even in the constitution that a light beam enters a port other than a target port during switching of an optical path, it is possible to block an optical path for each of the separated plural wavelengths and to prevent occurrence of dynamic crosstalk during switching of the selected wavelength into any port.

A wavelength selecting optical switch according to a second embodiment has basically the same constitution as that according to the first embodiment. In the wavelength selecting optical switch according to the second embodiment, the shutter array 6 has a function of making light intensity (transmission loss) variable for each of signal light having different wavelengths, in addition to the function of blocking signal light having a specific wavelength.

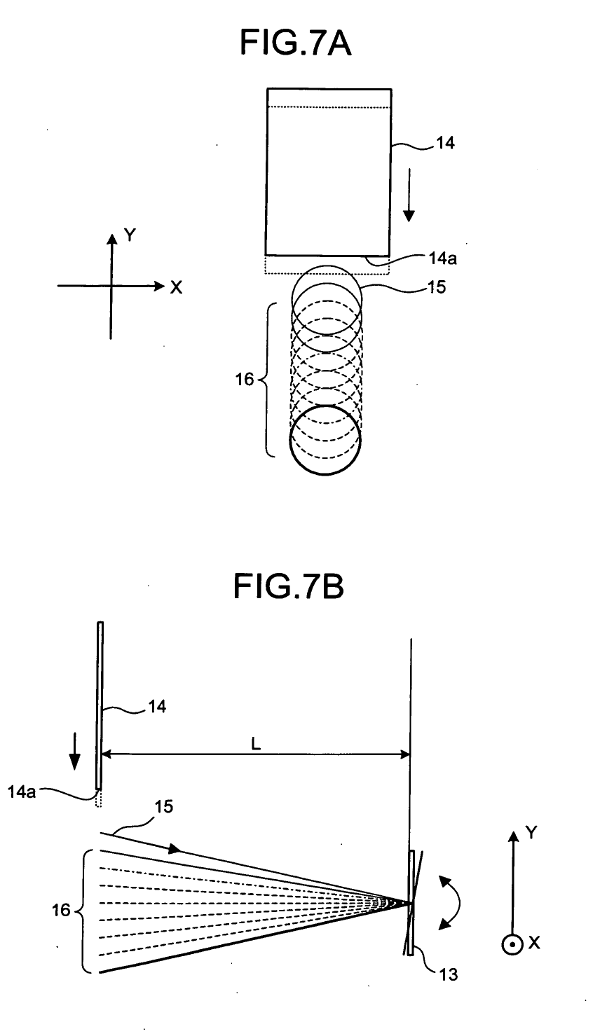

FIG. 7A is a front view of an arrangement according to the second embodiment of the present invention; FIG. 7B is a side view of an arrangement shown in FIG. 7A. In FIG. 7B, only a center position of a light beam is depicted for convenience of illustration. Changing light intensity is synonymous with changing transmission loss. The micro shutter 14 explained in the first embodiment is so configured that it completely shields the light in its closed state.

The micro shutter 14 is formed into a rectangular shape viewed from the front side, and the micro shutter 14 will move downward (Y direction) as shown by the dotted line when it is closed. As a result, an edge 14a of the lower end of the micro shutter 14 blocks a part of the input light beam 15. When the micro shutter 14 moves, the input light beam 15 is attenuated by the micro shutter 14. The micro shutter 14 moves such an amount that will not cover over the light beam reflected by the micro mirror 13, i.e., the output light beam 16.

Thus by changing the blocking amount with respect to the input light beam 15 by controlling the moving amount of the micro shutter 14, it is possible to correspondingly change the transmission loss of the light.

As a result, even when the optical path is switched into the Y direction in the drawing through change in the angle of the micro mirrors 13, only a part of the input light beam 15 but not the output light beam 16 is blocked, so that a specified transmission loss can be stably obtained. In addition, a distance L between the micro mirror 13 and the micro shutter 14 is not necessarily large, and the interval therebetween can be reduced corresponding to the changing angle of the micro mirror 13, so that it is possible to reduce the apparatus size. Additionally, it is possible to block a part of the input light beam 15 without using the diffraction grating 2 having large wavelength dispersion.

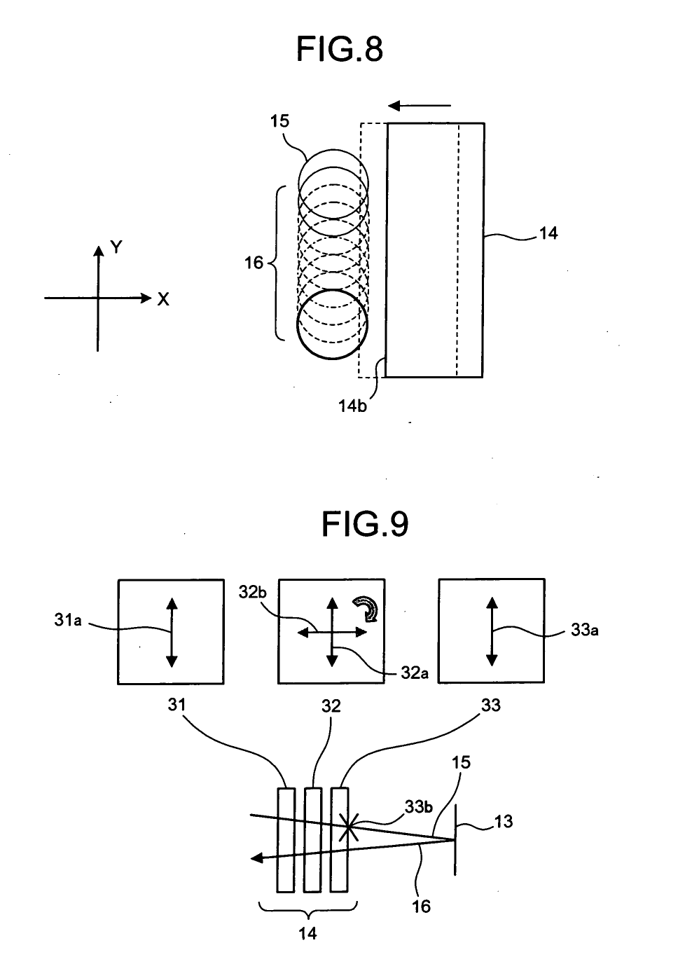

FIG. 8 is a front view of a modification of the arrangement shown in FIG. 7A. In the arrangement shown FIG. 7A, the micro shutter 14 is disposed in the direction (Y direction) in which the light is reflected by the angle of the micro mirror 13; however, in the arrangement shown in FIG. 8, the shutter 14 moves in the lateral direction (the direction in which the reflected light moves (the direction perpendicular to Y direction (X direction)). Accordingly, the micro shutter 14 is formed into a shape slightly larger in the longitudinal direction so as to cover a part of the input light beam 15 and a part of the output light beam 16 in any angle of the reflected light.

The input light beam 15 is reflected in a direction that crosses with the moving direction (X direction) of the micro shutters 14 at right angles. Therefore, the output light beam 16 can be securely blocked (or not blocked) by the micro shutter 14 even when the reflecting direction (outgoing direction) of the output light beam 16 is different as a result of change in the angle of the micro mirror 13. Accordingly, the transmission loss will not change after switching the optical path.

According to the second embodiment, it is possible to change the light intensity (transmission loss) by shifting the micro shutter 14 to partially block the light. Also it is possible to change the light transmission loss in such a manner that the transmission loss will not change depending on the angle even when the angle of the micro shutter 14 is changed depending on the switching of optical path.

In the first and the second embodiments explained above, the micro shutters 14 is implemented by a movable shutter using an electrostatic attraction-based movable element (MEMS shutter), however, a shape memory alloy element and a heat-generative heater can also be used. In this case, the micro shutter 14 is implemented by the shape memory alloy element, and the micro shutter 14 is driven by the heat-generative heater. First, heat is applied to the heat-generative heater, and this heat causes the shape memory alloy element to deform. As a result of deformation of the shape memory alloy element, the micro shutter 14 closes. The shape memory alloy element will recover the memorized original shape when removed from the heat. As a result of recovering the original shape, the micro shutter 14 opens again. In this manner, by using a shape memory alloy element for the micro shutter 14, the shape of the micro shutter 14 can be self-maintained. Therefore, there is an advantage that no electric power is consumed unless the shutter operates.

As another exemplary constitution of a movable shutter, a thermal actuator and a heat-generative heater can be used. In this case, the thermal actuator deforms through expansion by the heat-generative heater. This deformation of the thermal actuator impels the micro shutter 14 to move. Owing to this impelling force, the thermal actuator causes the micro shutter 14 to close. The thermal actuator will contract when it is removed from the heat. As a result of contraction of the thermal actuator, the micro shutters 14 opens again.

Furthermore, as another constitution of the movable shutter, a piezoelectric device can be used. The piezoelectric element changes in volume due to piezoelectric effect when electric power is applied to the piezoelectric element. This change in volume functions as a closing force for the micro shutter 14. Upon stopping application of electric power, the piezoelectric element recovers its original volume. As a result, the micro shutter 14 opens again. By using the piezoelectric element, it is possible to make the micro shutter 14 operate at relatively high speed.

In the wavelength selecting optical switches according to the first and the second embodiments, the micro shutter 14 (blocking member) that moves forward/back on the optical path was used, and as other blocking member, an optical shutter fixedly provided on an optical path can also be used. The optical shutter dispense with a moving mechanism for moving the micro shutter 14. In a wavelength selecting optical switch according to a third embodiment of the present invention, an optical shutter composed of a polarized wave rotation element and a light polarizer is used as the micro shutter 14 shown in FIG. 3. As shown in FIG. 3, the shutter array 6 consists of M micro shutters 14, and each of the M micro shutters 14 is implemented by the optically shutter composed of a polarized wave rotation element and a light polarizer. Other constitution is similar to that of the first embodiment.

FIG. 9 is a view for illustrating an optical shutter using two light polarizers and a polarized wave rotation element according to the third embodiment. As shown in FIG. 9, two light polarizers that allow passage of only specific polarized light are prepared in the same wave polarization direction. These polarizers are respectively named as a polarizer 31 and a polarizer 33, both of which have the same wave polarization direction as shown by a polarized wave 31a and a polarized wave 33a. Also the wave polarization direction of the input light beam 15 is as same as the direction of the polarized wave 31a and the polarized wave 33a. The optical shutter includes a polarization rotary element 32 between the two polarizer 31 and polarizer 33.

The polarization rotary element 32 allows light to pass through when the wave polarization direction of a polarized wave 32a is as same as that of the polarized wave 31a of the polarizer 31 and the polarized wave 33a of the polarizer 33. On the other hand, it blocks light at a surface 33b of the polarizer 33 by making the wave polarization direction perpendicular to that of the polarized wave 31a and the polarized wave 33a, as shown by a polarized wave 32b. In this manner, by controlling the direction of the polarized wave, it is possible to control blocking/passage of the light. Passage/locking of the light described above can be achieved for each wavelength by using each of the M micro mirrors 13.

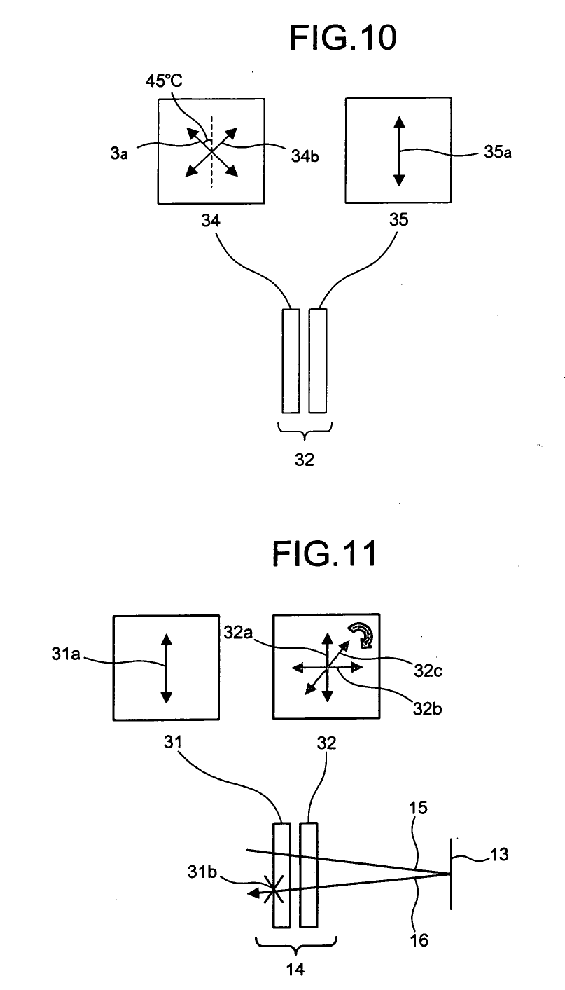

FIG. 10 is a view for illustrating a constitution of the polarization rotary element 32. The polarization rotary element 32 illustrated in FIG. 9 is composed of a phase difference-variable element 34 having an optical axis inclined plus 45 degrees or minus 45 degrees with respect to an input polarized wave, and a ¼ wavelength plate 35 having an optical axis as same as or perpendicular to that of an input polarized wave. The phase difference-variable element 34 is switched between the directions shown by the polarized wave 34a and the polarized wave 34b. The ¼ wavelength plate 35 gives a phase difference of 90 degrees between a light polarized component which is parallel to an optical axis of a transmitting light beam and a light polarized component witch is perpendicular to the optical axis. A direction of polarized wave of the ¼ wavelength plate 35 is denoted by the numeral 35a. In the case of rotating the polarized wave by 90 degrees as shown in FIG. 9, the phase of the phase difference-variable element 34 can be changed by 180 degrees. As shown in FIG. 11 described below, in rotating a polarized wave by 45 degrees, the phase of the phase difference-variable element 34 can be changed by 90 degrees.

The phase difference-variable element 34 can be realized by using liquid crystal. In this case, the polarization rotary element 32 is a liquid crystal-type polarization rotary element. Liquid crystal is preferable because of its relatively low price. However, since liquid crystals and polarizers have dependency on light polarization, they are preferably constituted so as not to depend on light polarization.

As the phase difference-variable element 34, an electro-optic polarization rotary element using an electro-optic element can be used. Since an electro-optic effect occurs or disappears in very short time on the order of micro second, an advantage of high-speed operation is obtained.

A magneto-optic polarization rotary element using a variable Faraday rotor as the polarization rotary element 32 can be used in place of the phase difference-variable element 34. The variable Faraday rotor is composed of combination of a Faraday element (magnet-optic crystal), a permanent magnet that applies a magnetic field from two directions which are different by 90 degrees on the Faraday element, and an electromagnet.

In this case, the Faraday element is magnetized in the direction of the synthetic magnetic field synthesized from a fixed magnetic field provided by a permanent magnet and a variable magnetic field provided by the electromagnet, and the synthesized magnetic field is set to have such an intensity that is sufficient for magnification to saturate. Accordingly, a magnetization vector of the Faraday element varies in its direction while the magnitude thereof is constant. Therefore, a magnetization component which is parallel to the advance direction of the light varies depending on the direction of the synthetic field, namely magnitude of variable magnetic field by the electromagnet. And a Faraday rotation angle depending on the magnetization component which is parallel to the advance direction of light varies in accordance with the magnitude of the magnetic field by the electromagnet.

The phase difference-variable element 34 has a phase which is adjusted to any value by a phase difference adjusting unit (not shown). When the phase difference-variable element 34 is of the type such as liquid crystal whose phase is changed by an electric field, the phase difference adjusting unit makes change to the phase by changing the electric field to be applied to the phase difference-variable element 34. With the constitution of FIG. 15, a polarized wave is rotated through a change in phase. When a polarized wave is rotated by a magneto-optic effect by a variable Faraday rotor or the like, a magnet field is varied by changing an electric field to a not-illustrate electromagnet to thereby cause the polarized wave to rotate.

As explained above, according to the third embodiment, it is possible to optically switch blocking/passage of light. Therefore, it is possible to prevent aged deterioration of a shutter resulting from mechanical movement and to enable high-speed operation.

The light intensity (that is transmission loss) can be changed for each wavelength of signal light by using only one polarizer in the third embodiment. This case is explained below as a fourth embodiment of the present invention. In the fourth embodiment, since light passes through an optical shutter twice, to provide the optical shutter with not only an ability to block light but also an ability to vary transmission loss, only one polarizer as shown in FIG. 11 in place of two polarizers as shown in FIG. 9 is provided. In the fourth embodiment, as to this polarizer, polarization rotation angle is varied in the range of between 0 and 45 degrees in one way. FIG. 11 is an explanatory view of an optical shutter based on one polarized and a polarization rotary element according to the third embodiment. As shown in FIG. 11, the polarizer 31 through which only a specific polarized light is allowed to pass is prepared. The direction of wave polarization of the polarizer 31 is represented by the polarized wave 31a. Additionally, the polarization rotary element 32 is prepared at the top of the polarizer 31. Incident light to these polarizer 31 and polarization rotary element 32 and emission light from the micro mirror 13 is allowed to pass through in both ways. As shown by the polarized wave 32a, the wave polarization direction of the polarization rotary element 32 coincides with that of the polarized waver 31a when light is allowed to pass through. On the other hand, when the light is blocked, as shown by the polarized wave 32c, the wave polarization direction is inclined 45 degrees with respect to the polarized wave 31a.

When only the polarizer 31 is used, the polarized wave is rotated 45 degrees in one way, and the polarized wave is rotated 90 degrees in both ways when it enters the polarization rotary element 32 again after reflected by the micro mirror 13, resulting that the wave polarization direction will be the polarized wave 32b after traveling both ways. As a result, light is blocked at the surface 31b of the polarizer 31. In this manner, by controlling the direction of the polarized wave, it is possible to control blocking/passage of the light. Passage/locking of the light described above can be achieved for each wavelength by using each of the M micro mirrors 13.

In this case, light is blocked when incident light passes twice while reflected by the micro mirrors 13. Furthermore, in the constitution using only one polarizer 31, only half polarization rotation angle is required compared to the constitution using two polarizer 31 and polarizer 33, and only one polarizer is required, power consumption and number of components of the polarization rotary element 32 can be advantageously reduced.

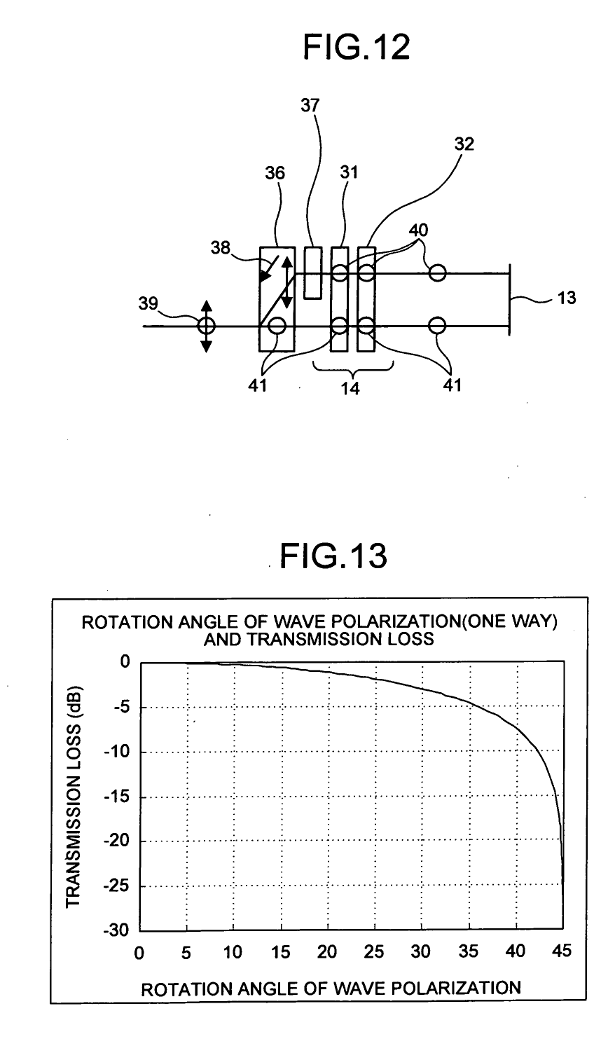

FIG. 12 is a top view of a wavelength selecting optical switch which makes the incident light not depend on the light polarization. The constitution shown in FIG. 12 is obtained by making the constitution employing only one polarizer shown in FIG. 11 not depend on light polarization. The micro mirror 13, the polarizer 31 and the polarization rotary element 32 are configured in a similar manner as those of the optical shutter shown in FIG. 11, however, in the present constitution, a birefringent plate 36 and a ½-wavelength plate 37 are added. The birefringent plate 36 has a birefringent crystal axial direction 38.

The birefringent plate 36 separates an incident polarized wave 39 which is incident light thereto into two polarized light 40 and 41 that cross at right angles. The polarized light 40 advances to the ½-wavelength plate 37 along the birefringent crystal axial direction 38. The polarized light 40 is rotated 90 degrees at the ½-wavelength plate 37, and then enters the polarizer 31. On the other hand, the polarized light 41 directly enters the polarizer 31. In this manner the separated polarized light 40 and 41 have the same light polarization direction, so that properties of incident light will not change depending on the polarization state of the incident light and independency on the light polarization is realized.

FIG. 13 is a graph for explaining a relationship between a rotation angle of wave polarization and a transmission loss in the fourth embodiment. The polarized wave can be rotated in the range of 0 to 45 degrees in one-way by means of the polarization rotary element 32, and in the range of 0 to 90 degrees in both ways. In this manner it is possible to make the transmission loss variable as shown in FIG. 13. In the graph of FIG. 13, the horizontal axis represents polarization rotation angle and the vertical axis represents transmission loss. When the rotation angle of wave polarization is 45 degrees, the transmission loss peaks as illustrated in FIG. 11 and incident light is blocked, however even when the polarization rotation angle is less than 45 degrees, the transmission loss increases as the polarization rotation angle increases as shown in FIG. 13.

As described above, since only one polarizer is required in the fourth embodiment it is advantageous in that power consumption and number of components of the polarization rotary element 32 can be reduced.

In the wavelength selecting optical switches according to the third and the fourth embodiments, the optical shutter is implemented by a shutter composed of the polarization rotary element 32 and the polarizer 31 and the polarizer 33, however, a wavelength-variable filter can be used as another constitution for the optical shutter. This constitution is explained below as a fifth embodiment of the present invention. A non-illustrated wavelength adjusting unit is connected to a wavelength-variable filter, and a transmission wavelength of the wavelength-variable filter is adjusted by application of an electric field necessary to adjust the transmission wavelength of the wavelength-variable filter.

As shown in FIG. 3, the shutter array 6 consists of M micro shutters 14, and for each of the M micro shutters 14, the wavelength-variable filter is used. Alternatively, the number of the micro shutter 14 can be one or values less than M rather than M because the wavelength-variable filter selectively block light of a specific wavelength. In any cases, light of necessary wavelengths can be independently blocked. Other constitution is similar to that of the first embodiment.

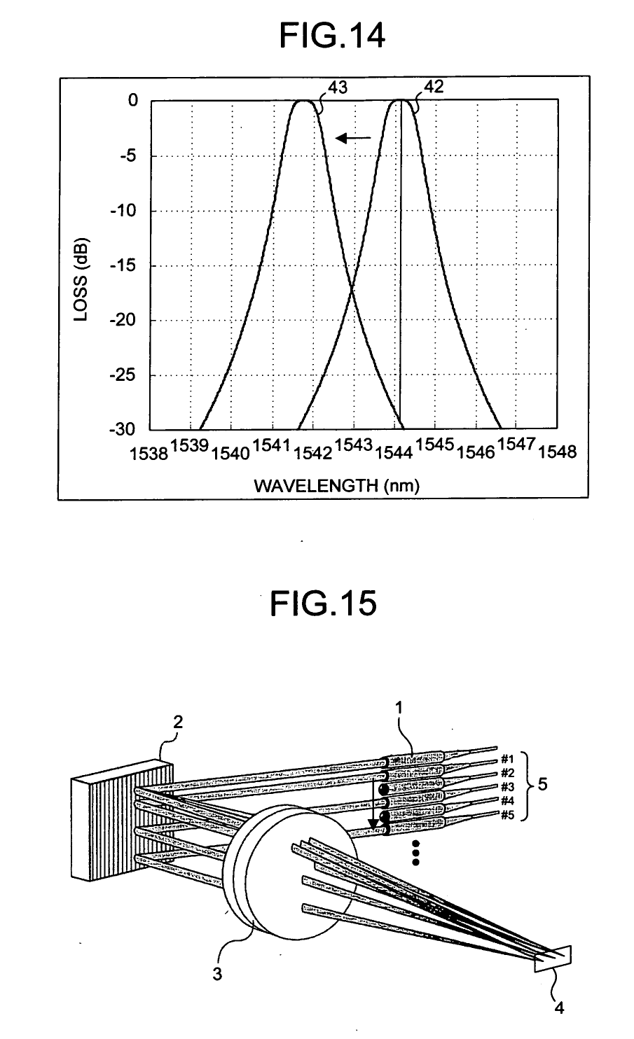

FIG. 14 is a graph for explaining the wavelength-variable filter according to the fifth embodiment. The wavelength-variable filter can increase the loss of light signal for a specific wavelength. That is, it is possible to vary the wavelength characteristic of a filter thorough which only a specific wavelength is allowed to pass. In brief, it is possible to shift the transmission wavelength.

As shown in FIG. 14, in the case of graph 42, the light having a wavelength of about 1544 nanometers takes the minimum transmission loss. That is, the light of 1544 nanometers transmits and the shutter is brought into an open state. By transiting to the state shown by a graph 43, by changing the state of the wavelength-variable filter, it is possible to make the transmission loss of the light having a wavelength of about 1544 nanometers sufficient large, to bring the shutter in a closed state.

In this manner light of a specific wavelength is allowed to pass through or reflected, and as a result, the light can be substantially blocked. Since only light of a specific wavelength can enter a specific micro shutter, by adjusting the specific wavelength so that the wavelength-variable filter blocks the wavelength of the light signal, it is possible to block the light. As a filter that allows transmission of a specific wavelength, an etalon filter and an optical film bandpass filter can be exemplified.

As such a wavelength-variable filter, a diaphragm type etalon, an etalon using a piezoelectric element, a liquid crystal type etalon, an optical film bandpass filter using electro-optic effect and the like various filters are proposed and any of these can be used.

As explained above, according to the fifth embodiment, an advantage is obtained that it is possible to optically block light by directly designating a wavelength of the target light to be blocked rather than blocking the light by designating an optical path. Then by the shutter array 6 consisting of the micro shutters 14 having an ability to block the light, disposed directly before the micro mirrors 13 for each wavelength constituting the mirror array 4, it is possible to provide an wavelength selecting optical switch which does not cause a dynamic crosstalk during switching of optical path with a simple constitution. In addition to this, the micro shutter 14 can be constituted in various manners, and also the wavelength selecting optical switch having variable attenuation ability for adjusting intensity of wavelength signal light can be simply constituted.

Furthermore, the wavelength selecting optical switch described above is constituted to conduct switching of the light for each wavelength by providing with a wavelength dispersing element such as diffraction grating, whoever the present invention can be applied to an optical path changing-over switch not including a wavelength dispersing element. That is, it can be applied to an optical path changing-over switch wherein incident wavelengths to a plurality mirrors are different from each other, and by changing the angles of the mirrors, the light is emitted while changing optical paths of the incident light in selected directions for each wavelength, for blocking the optical path for each wavelength.

The present invention is advantageous in that when an optical path which is to be an output end of light having a plurality of wavelengths is switched, it is possible to prevent a dynamic crosstalk from occurring during the switching operation.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An optical path changing-over switch in which wavelengths entering a plurality of mirrors are different from each other, and light is emitted while switching optical paths of light into selected directions for each wavelength by changing angles of the mirrors, the optical path changing-over switch comprising:
a shutter situated near an incident position that is a position at which the light falls onto the mirrors and has a plurality of blocking members that prevent or allow light to be incident onto respective mirrors; and
a control unit that controls a blocking member corresponding to a mirror of which an angle is to be changed so that the blocking member prevents the light to be incident onto the corresponding mirror.

2. The optical path changing-over switch according to claim 1, wherein the control unit controls the blocking member so that the blocking member prevents the light to be incident onto the mirror during the period from starting of the angular change of the mirror to the end of the angular change.

3. A wavelength selecting optical switch comprising:
a wavelength dispersing element that separates an incident light into a plurality of light beams based on wavelengths that travel at different angles and emits the light beams;
a lens that focuses each of the light beams at a different position;
a mirror array including a plurality of rotatable mirrors, each mirror being located at a position corresponding to the position where the lens focuses the light beams, the mirror array reflecting the light beams toward the wavelength dispersing element via the lens, directions of the light beams reflected by the mirrors is in accordance with angles of the mirrors;
a plurality of output ports provided at positions where the light beams returned depending on the mirror angles of the mirror array by the wavelength dispersing element are condensed; and
a shutter having a blocking unit that blocks the light beams, wherein the shutter is disposed in an optical path of a corresponding light beam from the wavelength dispersing element for each mirror,
wherein when angles of the mirrors are changed, a light beam is blocked by a corresponding blocking unit.

4. The wavelength selecting optical switch according to claim 3, wherein the blocking unit provided for the shutter is formed of a filter having a filter characteristic that attenuates the light.

5. The wavelength selecting optical switch according to claim 3, wherein the blocking unit blocks incident light to the mirror by moving a blocking member.

6. The wavelength selecting optical switch according to claim 5, wherein the blocking member moves in a direction along a direction of light reflected by the mirror as a result of angular change of the mirror.

7. The wavelength selecting optical switch according to claim 6, wherein the control unit controls movement of the blocking member of the shutter so that it blocks a part of the incident light to the mirror.

8. The wavelength selecting optical switch according to claim 5, wherein the blocking member moves in a direction perpendicular to a direction along a direction in which the light is reflected by the mirror as a result of angular change of the mirror, and the control unit controls movement so as to block a part of incident light to the mirror and a part of light reflected by the mirror.

9. The wavelength selecting optical switch according to claim 6, wherein the shutter moves the blocking member using an electrostatic attraction-based variable element.

10. The wavelength selecting optical switch according to claim 8, wherein the shutter moves the blocking member using an electrostatic attraction-based variable element.

11. The wavelength selecting optical switch according to claim 6, wherein the shutter moves the blocking member using a piezoelectric element.

12. The wavelength selecting optical switch according to claim 8, wherein the shutter moves the blocking member using a piezoelectric element.

13. The wavelength selecting optical switch according to claim 6, wherein the blocking member is a thermal actuator, and the shutter moves the blocking member by heat applied by a heat-generative heater.

14. The wavelength selecting optical switch according to claim 8, wherein the blocking member is a thermal actuator, and the shutter moves the blocking member by heat applied by a heat-generative heater.

15. The wavelength selecting optical switch according to claim 6, wherein the blocking member is a shape memory alloy element, and the shutter moves the blocking member by heat applied by a heat-generative heater.

16. The wavelength selecting optical switch according to claim 8, wherein the blocking member is a shape memory alloy element, and the shutter moves the blocking member by heat applied by a heat-generative heater.

17. The wavelength selecting optical switch according to claim 3, wherein the blocking unit includes a polarization rotary element and a polarizer, and blocks the light with the polarizer by rotating a polarized wave of the light by the polarization rotary element.

18. The wavelength selecting optical switch according to claim 17, wherein the blocking unit allows incident light to the mirror and light emitted from the mirror to pass through the polarization rotary element and the polarizer in both ways, and changes a transmission loss of the light depending on the polarization rotation angle by the polarization rotary element.

19. The wavelength selecting optical switch according to claim 17, further comprising:
a birefringent plate that separates incident light into two polarized light beams which intersect at right angles, provided on a light incident side for the blocking unit; and
a ½-wavelength plate that rotates one of the polarized wave of light dispersed by the birefringent plate by 90 degrees,
wherein the two polarized waves of light enters the blocking members in the same direction.

20. The wavelength selecting optical switch according to claim 17, wherein the polarization rotary element includes
a phase difference-variable element having an optical axis inclined plus 45 degrees or minus 45 degrees with respect to an input polarized wave, and changing a phase of incident light, and
a ¼ wavelength plate having an optical axis as same as or perpendicular to that of an input polarized wave, and rotating a polarized wave of the light having passed through the phase difference-variable element based on the phase of the incident light to the phase difference-variable element.

21. The wavelength selecting optical switch according to claim 20, wherein the phase difference-variable element is implemented by using liquid crystal or an electro-optic element.

22. The wavelength selecting optical switch according to claim 17, wherein the polarization rotary element is implemented by using a variable Faraday rotor.

23. The wavelength selecting optical switch according to claim 3, wherein in changing one angle of the mirror, the control unit blocks the light with the blocking unit corresponding to the mirror, and allows the light to pass from the position of the blocking unit after the angle of the mirror is changed.

24. The wavelength selecting optical switch according to claim 23, wherein the control unit blocks light with the blocking unit corresponding to the mirror to be subjected to angular change, while allows the light to pass through the blocking unit corresponding to the mirror not to be subjected to angular change.

25. The wavelength selecting optical switch according to claim 3, wherein a reflective wavelength dispersing element is used as the wavelength dispersing element, and on one side centered at the wavelength dispersing element, the input port and the output port are disposed, while on the other side the lens, the mirror array, and the shutter are disposed.

26. The wavelength selecting optical switch according to claim 5, wherein a transmission loss of the light beam is controlled by a moving amount of the blocking member or a rotation amount of the polarized wave of the polarization rotary element.

27. The wavelength selecting optical switch according to claim 17, wherein a transmission loss of the light beam is controlled by a moving amount of the blocking member or a rotation amount of the polarized wave of the polarization rotary element.

28. The wavelength selecting optical switch according to claim 23, wherein a transmission loss of the light beam is controlled by a moving amount of the blocking member or a rotation amount of the polarized wave of the polarization rotary element.

29. The wavelength selecting optical switch according to claim 25, wherein a transmission loss of the light beam is controlled by a moving amount of the blocking member or a rotation amount of the polarized wave of the polarization rotary element.
